(19) United States
(12) Patent Application Publication
(10) Pub. No.: US 2026/0340954 A1
(43) Pub. Date: Oct. 29, 2026

(54) DEVICES, MEDIA, AND METHODS FOR MURAL MAKER EXTENDED REALITY GUIDE

(71) Applicant: 3M INNOVATIVE PROPERTIES COMPANY, St. Paul, MN (US)

(72) Inventors: Amir Ahmadi, Savannah, GA (US); Andrew P. Baussan, West St. Paul, MN (US); Joseph B. Horowitz, Brooklyn, NY (US); Maya Pandurangan, Edison, NJ (US)

(21) Appl. No.: 19/124,420

(22) PCT Filed: Nov. 8, 2023
(86) PCT No.: PCT/IB2023/061285

§ 371 Date: Apr. 25, 2025

Related U.S. Application Data
(60) Provisional application No. 63/428,450, filed on Nov. 29, 2022.

(51) Int. Cl. G06T 19/00

(52) U.S. Cl. CPC G06T 19/006

(57) ABSTRACT

A method includes detecting, via a sensor, a physical surface within a line of sight of the sensor. The method also includes providing a virtual surface corresponding to the physical surface. The method further includes receiving an image from a source other than the sensor. The method also includes dividing the image into pieces. The method additionally includes displaying, within the virtual surface, placement indicators each denoting a location on the physical surface to place a physical object corresponding to one of the image pieces.

### BACKGROUND

Users may desire to create wall murals as artistic creations that are aesthetically pleasing. With the advent of adhesive paper notes, such as the Post-it® Note, users were able to place multiple notes on a wall, and even attempt to create a mural. However, creating such a mural on a wall can also be a difficult and time-consuming process.

### SUMMARY

In one embodiment, one or more non-transitory computer-readable media encoded with instructions that, when executed, configure a computing device for detecting, via a sensor, a physical surface within a line of sight of the sensor. The one or more non-transitory computer-readable media include further instructions for providing a virtual surface corresponding to the physical surface and receiving an image from a source other than the sensor. The one or more non-transitory computer-readable media include additional instructions for dividing the image into pieces and displaying, within the virtual surface, placement indicators each denoting a location on the physical surface to place a physical object corresponding to one of the image pieces.

In another embodiment, a method includes detecting, via a sensor, a physical surface within a line of sight of the sensor. The method also includes providing a virtual surface corresponding to the physical surface. The method further includes receiving an image from a source other than the sensor. The method also includes dividing the image into pieces. The method additionally includes displaying, within the virtual surface, placement indicators each denoting a location on the physical surface to place a physical object corresponding to one of the image pieces.

In a further embodiment, a computing device includes a sensor configured to detect a physical surface within a line of sight of the sensor and memory. The computing device also includes a processor coupled to the memory and the sensor, wherein the processor is configured to provide a virtual surface corresponding to the physical surface, receive an image from a source other than the sensor, and divide the image into pieces. The computing device additionally includes display hardware coupled to the processor and memory, wherein the display hardware is configured to display, within the virtual surface, placement indicators each denoting a location on the physical surface to place a physical object corresponding to one of the image pieces.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims.

FIG. 1 schematically depicts a design selection interface in accordance with embodiments herein;

FIG. 2 schematically depicts a mural design interface in accordance with embodiments herein;

FIG. 3 schematically depicts extended-reality mural creation in accordance with embodiments herein;

FIG. 4 is a flowchart for extended-reality mural creation in accordance with embodiments herein; and

FIG. 5 is a block diagram of mobile device computing hardware utilized to implement various embodiments herein.

### DETAILED DESCRIPTION

The present disclosure describes techniques for using extended reality to assist users in recreate, in piecemeal fashion, digital works in physical form. In embodiments, users may desire to create a mural based on a design they select. Rather than merely placing Post-it® Notes of varying colors individual on a wall, which can be slow and problematic in terms accuracy, a user can utilize (for example) augmented reality (AR) to identify or designate a virtual surface overlain upon a physical surface, such as a wall. By using a virtual surface, the user can not only see the virtual surface broken up into (for example) a grid corresponding to the Post-it® Notes. The user can be advantageously guided in the creation of their mural by having indicators (such as numbers) displayed to guide the user, so that they use one color per instance of a number, a different color for another number, and so forth. In this way, AR allows the user to more accurately and quickly create their mural without worrying about where each individual Post-it® Note fits into the grand scheme of their mural. Instead, the user can literally create-by-numbers.

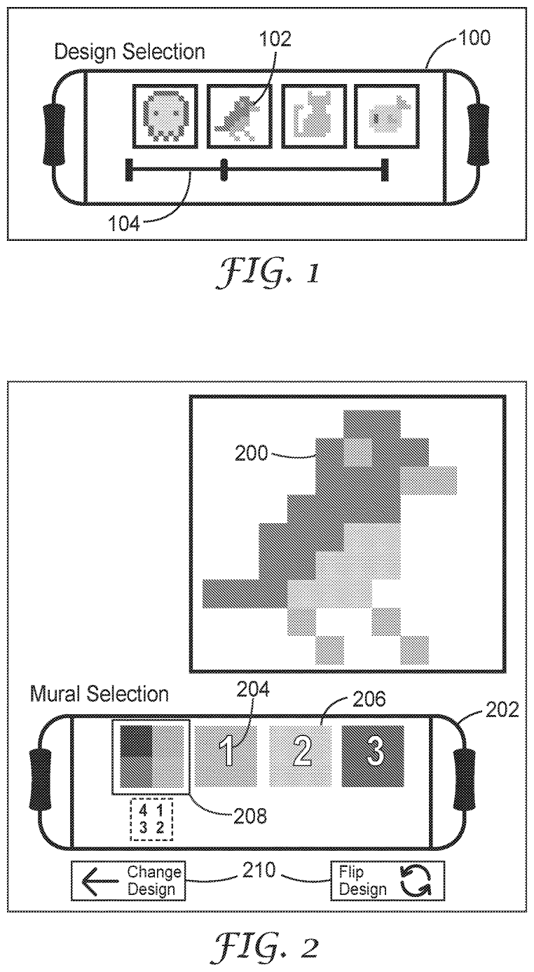

Referring now to FIG. 1, a design selection interface 100 is depicted in an AR environment, although any suitable environment may be utilized, which by way of non-limiting examples may include virtual reality (VR), mixed reality (MR), extended reality (XR), and the like. In this embodiment, AR utilizes the real-world environment with an overlay of virtual data, metadata, and the like, while VR uses all (or a mostly) virtual representation of the environment. MR in this embodiment may be regarded as capable of performing AR and VR, while XR may be regarded as offering all possible functionalities of AR, VR, and/or MR blending the physical and virtual worlds beyond the visible background. Although a wearable headset is depicted in this embodiment, any suitable type of technology may be utilized such as electronic glasses, hologram/projection, a 2-dimensional and/or a 3-dimensional display on a device such as a smartphone, laptop, desktop computer, tablet, and the like. The design selection interface 100 may appear, by way of non-limiting example, as a floating interface in an AR environment.

The design selection interface 100 may utilize any type of graphical or other interface to select or otherwise indicate a design 102. A design 102 may be any type of image (jpg, gif, png, vector graphic, or the like) created electronically or captured from the physical world. In some embodiments, a design 102 may be a simplified image having a reduced resolution. A user may upload or capture an image using an image capture device that may include, by way of non-limiting example, a sensor on their AR headset. A sensor in this embodiment may be a camera, LIDAR sensor, Time-of-Flight (TOF) sensor, ultrasound sensor, sonar, infrared sensor, and/or any other type of sensor capable of detecting a surface and/or any type of detectable frequency in within the electromagnetic spectrum (i.e., ionizing radiation, visible light, microwaves, radiowaves). A slider 104 or any other interface tool(s) may be utilized to browse available designs 102.

Referring now to FIG. 2, once a design has been selected, a mural design 200 version of the design may be utilized to display it more detail. The mural design 200 may be represented as a collection of mural pieces 206. In this embodiment, the mural design 200 may be a reduced resolution representation, so that, for example, a Post-it® Note may be used to represent one pixel. This may be further represented, for example, by a placement indicator 204, such as a number or any other suitable type of placement indicator 204 that a user may recognize, which may be utilized/overlain upon a mural piece 206. A piece legend 208 may be utilized to show the user the available colors being utilized and/or how the placement indicators 204 correspond to mural pieces 206 of different colors. In some embodiments, a mural piece 206 may be represented by more than one color and/or pixel value. Mural interface options 210 may include flipping and/or rotating the mural design 200 and changing the mural design 200.

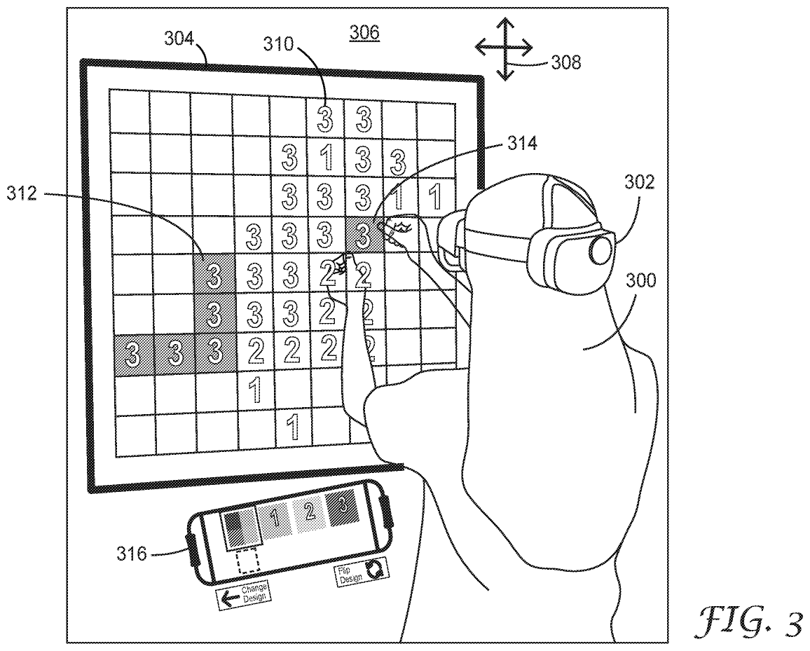

Referring now to FIG. 3, a user 300 is depicted extended reality hardware 302 to create a mural design. A virtual surface 304 in this embodiment may be overlain upon a physical surface 306, with a virtual surface orientation 308 displayed to provide the user 300 with continued orientation. The user 300 may, by way of non-limiting example, create the virtual surface 304 by identifying a point on the physical surface 306 (such as with their finger or eye gaze) and dragging their finger or gaze in augmented reality to identify the opposite corner of the virtual surface 304. In this way, the virtual surface 304 may remain overlain upon the physical surface 306 as the sensor of the extended reality hardware 302 updates a location of the physical surface 306 based upon movement of the user 300 with respect to the physical surface 306. Although the physical surface 306 is depicted here as a flat, vertical surface such as a wall, any suitable surface may be used, such as a floor, ceiling, flat wall having a gradient, a curved surface, an intersection of two surfaces, and the like. The virtual surface 304 may be divided into virtual pieces 312, which in this embodiment are a grid of squares or rectangles, but which in other embodiments may take any suitable shape. For example, the boundaries between the virtual pieces 312 may form triangles, diamonds, circles/ovals, and/or any other shape(s) which may or may not leave gaps between the boundaries of various virtual pieces 312.

One or more placement indicators 310 may be used to show the user 300 where to place a physical object such as a Post-it® Note of a certain color or type. In this non-limiting example depicted, some or all of the virtual pieces 312 may correspond to the design as depicted in FIG. 1 and/or the mural depicted in FIG. 2. In this way, each pixel value of the mural as depicted in FIG. 2 may correspond to a virtual piece 312. In this non-limiting example, the mural depicted in FIG. 2 is represented by three color values, with dark grey values being represented by a placement indicator 310 displayed as ‘3’, light grey values represented by a placement indicator 310 displayed as ‘2’, and medium grey values represented by a placement indicator 310 displayed as ‘1’. While in this embodiment there is no background value, one or more background colors may also be utilized and may be represented by one or more placement indicators 310. In some embodiments, a placement indicator may correspond to a color, pattern of colors, or shape of one of the physical objects 314 and/or virtual pieces 312.

The way in which the mural is displayed upon the virtual surface 304 may change based upon a variety of factors such as distance and/or time. By way of non-limiting example, at a farther augmented reality distance between the user 300 and the virtual surface 304, the virtual pieces 312 on the virtual surface 304 may display their respective color(s). However, as the user 300 moves closer to the virtual surface 304, some or all of the placement indicators 310 may come into view, such that the color values may fade or completely disappear, and/or vice versa. In some embodiments, the contents of some or all of the virtual pieces 312 may change with respect to time, such as alternating between color values and placement indicators 310, and the like.

By way of non-limiting example, the user 300 may manipulate a physical object 314 and place it upon a virtual piece. Continuing with this non-limiting example, the user 300 places a dark Post-it Note(® at a virtual piece 312 labeled as ‘3’, which corresponds to dark Post-it Notes®. In some embodiments, a virtual version of the physical object 314 (e.g., a ‘digital twin’) may be displayed in extended reality to assist the user 300. In some embodiments, the digital twin may be ‘snapped’ onto a virtual piece 312 as the user moves the physical object 314 near the virtual piece 312 to assist the user 300 in more accurate placement of the physical object 314 upon the physical surface 306. In some embodiments, the design interface 316 may reside (or ‘float’) near the virtual surface 304 to provide the user 300 with convenient access to the design interface 316 functionality discussed with respect to FIG. 2.

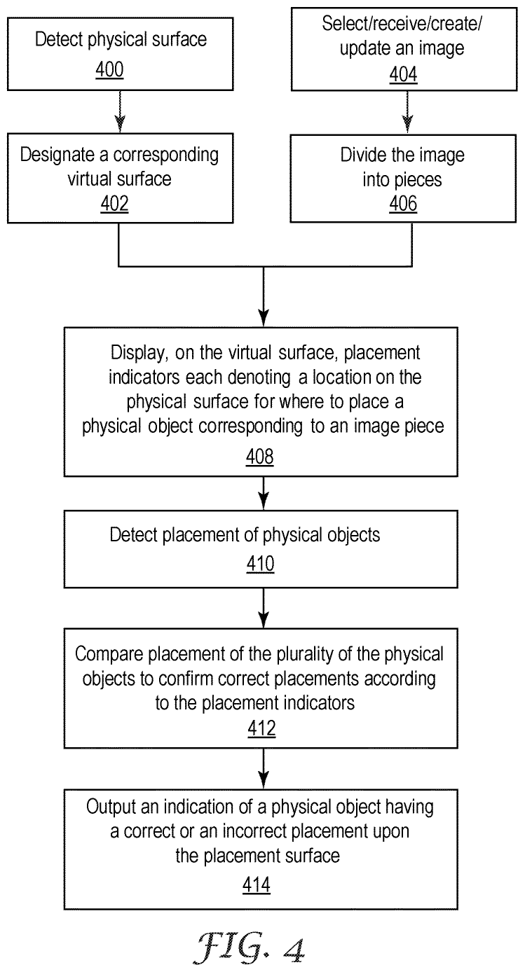

Referring now to FIG. 4, a flowchart for extended-reality mural creation according to one embodiment is depicted. At block 400, a physical surface may be detected. As discussed herein, a sensor or any other image-detection and/or object-detection device may be used as part of any suitable hardware, such as extended reality wearables, to detect a physical surface such as a wall. At block 402, a virtual surface corresponding to the physical surface may be designated. For example, the user may be wearing augmented reality hardware that allows them to draw the boundaries of the virtual surface upon the physical surface, such that the virtual surface will correspondingly change according to the proximity and perspective of the user with respect to the wall.

At block 404, an image (or design) may be selected, received, created, updated, and/or the like. For example, a user may upload an image that they previously created or saved. In some embodiments, the user may be prompted to approve or preview a lower-resolution version of the image that could correspond to a mural version. At block 406, the image may be divided into pieces that correspond, by way of non-limiting example, to each pixel value being associated with a particular color of Post-it® Note. It should be noted that blocks 404 and/or 406 may be performed independently of the timing of when blocks 400 and/or 402 are performed.

At block 408, placement indicators may be displayed on the virtual surface. As discussed herein, each placement indicator may denote an augmented reality location corresponding to a location upon the physical surface at which the user should place a physical object (such as a Post-it® Note). At block 410, placement of physical objects may be detected. For example, the same sensor, or different image-detection/object-detection hardware, may used to visually detect and/or track the physical objects that the user has placed upon the physical surface. At block 412, the placement of the plurality of the physical objects may be compared to confirm their respective correct placements according to the placement indicators. By way of non-limiting example, the location of each physical object may be compared to see whether it has been placed correctly according to the placement indicator and/or the corresponding virtual piece residing on the virtual surface. In this way, the virtual pieces and/or placement indicators may be overlain upon the physical objects and the accuracy of the user's placement of the physical objects may be apparent to the user in, for example, augmented reality. At block 414, an indication may be output regarding a physical object having a correct or an incorrect placement upon the placement surface. By way of non-limiting example, if any physical object (or its virtual twin) is placed in such a way that one or more of its sides is not within the boundaries of the virtual piece, then any violations of the boundaries of the virtual piece may be output to the user in the form of a graphical alert (e.g., blinking boundary, giving the boundary a different color such as red, and the like), an audio alert, and/or the like. In some embodiments, a user may be notified when a physical object (or its virtual twin) is placed correctly within the boundaries of the virtual piece. In this embodiment, the color of the physical object may be compared with the color value associated with the placement indicator, such that placement within the boundaries of the virtual piece and a correct color match to the placement indicator may be indicated to the user as a correct placement. In other embodiments, the color may not be matched and a correct placement may be based only upon placement of the physical object within the boundaries of the virtual piece. In some embodiments, the user may be notified once all the physical objects have been correctly placed on their correct locations on the physical surface within the virtual pieces of the virtual surface according to their respective placement indicators.

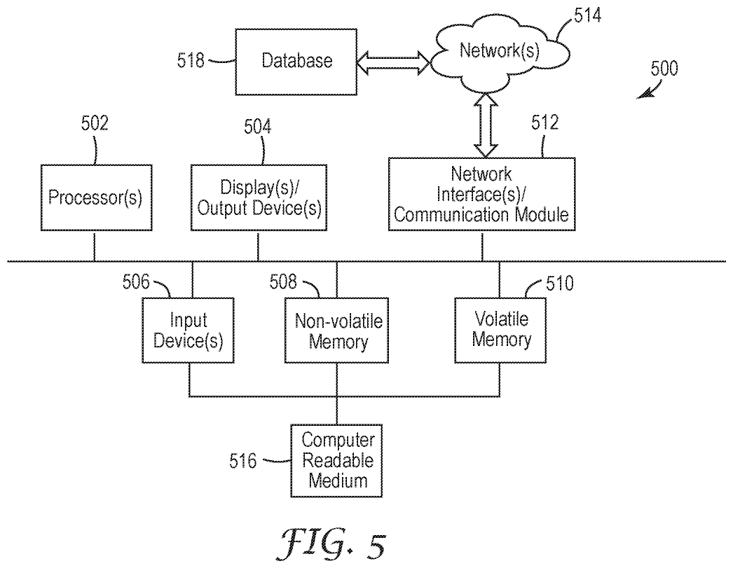

Referring now to FIG. 5, a block diagram illustrates computing hardware, such as an exemplary computing device 500, through which embodiments of the disclosure can be implemented. The computing device 500 described herein is but one example of a suitable computing device and does not suggest any limitation on the scope of any embodiments presented. Nothing illustrated or described with respect to the computing device 500 should be interpreted as being required or as creating any type of dependency with respect to any element or plurality of elements. In various embodiments, the computing device 500 may include, but need not be limited to, a desktop, laptop, server, client, tablet, smartphone, computing cloud or any other type of device that can utilize data. In an embodiment, the computing device 500 includes at least one processor 502 and memory comprising non-volatile memory 508 and/or volatile memory 510. The computing device 500 can include one or more displays, display hardware, and/or output devices 504 such as, for example, AR/VR/MR/XR hardware, monitors, speakers, headphones, projectors, wearable-displays, holographic displays, and/or printers. Output devices 504 may further include, for example, displays and/or speakers, devices that emit energy (radio, microwave, infrared, visible light, ultraviolet, x-ray and gamma ray), electronic output devices (Wi-Fi, radar, laser, etc.), audio (of any frequency), and the like.

The computing device 500 may further include one or more input devices 506 which can include, by way of example, any type of mouse, keyboard, disk/media drive, memory stick/thumb-drive, memory card, pen, touch-input device, biometric scanner, gaze and/or blink tracker, tracker, voice/auditory input device, motion-detector, camera, scale, and any device capable of measuring data such as motion data (e.g., an accelerometer, GPS, a magnetometer, a gyroscope, etc.), biometric data (e.g., blood pressure, pulse, heart rate, perspiration, temperature, voice, facial-recognition, motion/gesture tracking, gaze tracking, iris or other types of eye recognition, hand geometry, oxygen saturation, glucose level, fingerprint, DNA, dental records, weight, or any other suitable type of biometric data, etc.), video/still images, and audio (including human-audible and human-inaudible ultrasonic sound waves). Input devices 506 may include any type of device capable of receiving data, whether from another device, visual and/or audio data captured from the real world, object detection data, and the like. Input devices 506 may correspond to the sensor(s) described herein, such as a LIDAR sensor, Time-of-Flight (TOF) sensor, ultrasound sensor, sonar, infrared sensor, and/or any other type of sensor capable of detecting a surface/object and/or any type of detectable frequency in within the electromagnetic spectrum (i.e., ionizing radiation, visible light, microwaves, radiowaves). Input devices 506 may include cameras (with or without audio recording), such as digital and/or analog cameras, still cameras, video cameras, thermal imaging cameras, infrared cameras, cameras with a charge-couple display, night-vision cameras, three-dimensional cameras, webcams, audio recorders, and the like.

The computing device 500 typically includes non-volatile memory 508 (e.g., ROM, flash memory, etc.), volatile memory 510 (e.g., RAM, etc.), or a combination thereof. A network interface 512 can facilitate communications over a network 514 with other data source such as a database 518 via wires, a wide area network, a local area network, a personal area network, a cellular network, a satellite network, and the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and Fire Wire. Suitable cellular networks may include, but are not limited to, technologies such as LTE, WiMAX, UMTS, CDMA, and GSM. Network interface 512 can be communicatively coupled to any device capable of transmitting and/or receiving data via one or more network(s) 514. Accordingly, the network interface 512 can include a communication transceiver for sending and/or receiving any wired or wireless communication. For example, the network interface 512 may include an antenna, a modem, LAN port, Wi-Fi card, WiMax card, mobile communications hardware, near-field communication hardware, satellite communication hardware and/or any wired or wireless hardware for communicating with other networks and/or devices.

A computer-readable medium 516 comprises one or more plurality of computer readable mediums, each of which is non-transitory. A computer readable medium may reside, for example, within an input device 506, non-volatile memory 508, volatile memory 510, or any combination thereof. A readable storage medium can include tangible media that is able to store instructions associated with, or used by, a device or system. A computer readable medium, also referred to herein as a non-transitory computer readable medium, includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A non-transitory computer readable medium may also include, for example, a system or device that is of a magnetic, optical, semiconductor, or electronic type. A non-transitory computer readable medium excludes carrier waves and/or propagated signals taking any number of forms such as optical, electromagnetic, or combinations thereof.

The computing device 500 may include one or more network interfaces 512 to facilitate communication with one or more remote devices, which may include, for example, client and/or server devices. The network interface 512 may also be described as a communications module, as these terms may be used interchangeably. The database 518 is depicted as being accessible over the network 514 and may reside within a server, the cloud, or any other configuration to support being able to remotely access data and store data in the database 518.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. One or more non-transitory computer-readable media encoded with instructions that, when executed, configure a computing device for:
detecting, via a sensor, a physical surface within a line of sight of the sensor;
providing a virtual surface corresponding to the physical surface;
receiving an image from a source other than the sensor;
dividing the image into pieces; and
displaying, within the virtual surface, placement indicators each denoting a location on the physical surface to place a physical object corresponding to one of the image pieces.

2. The one or more non-transitory computer-readable media of claim 1 comprising further instructions for detecting placement of a plurality of the physical objects.

3. The one or more non-transitory computer-readable media of claim 2 comprising further instructions for:
comparing placement of the plurality of the physical objects to confirm correct placements according to the placement indicators; and
outputting an indication of a physical object having a correct or an incorrect placement upon the placement surface.

4. The one or more non-transitory computer-readable media of claim 1 wherein at least one of the physical objects comprises more than one color.

5. The one or more non-transitory computer-readable media of claim 1 wherein one of the physical objects is placed according to a placement indicator.

6. The one or more non-transitory computer-readable media of claim 5 wherein the placement indicator corresponds to a color, pattern of colors, or shape of the one of the physical objects.

7. The one or more non-transitory computer-readable media of claim 6 wherein each physical object has a single color and the placement indicators are numbers that correspond to the colors of the physical objects.

8. The one or more non-transitory computer-readable media of claim 1 wherein virtual pieces are separated by boundaries.

9. The one or more non-transitory computer-readable media of claim 8 wherein two of the boundaries form a non-orthogonal angle.

10. The one or more non-transitory computer-readable media of claim 1 wherein the physical surface has a curvature or comprises an intersection of two planes.

11. The one or more non-transitory computer-readable media of claim 1 comprising further instructions for:
displaying the image upon the virtual surface based upon the sensor being a distance from the physical surface; and
transforming, on the virtual surface, the image into the placement indicators based upon a change in the distance from sensor to the physical surface.

12. The one or more non-transitory computer-readable media of claim 1 comprising further instructions for snapping a virtual representation of a physical object onto the virtual surface.

13. The one or more non-transitory computer-readable media of claim 1 wherein providing a virtual surface further comprises an augmented reality display such that the virtual surface remains overlain upon the physical surface as the sensor updates a location of the physical surface.

14. A method comprising:
detecting, via a sensor, a physical surface within a line of sight of the sensor;
providing a virtual surface corresponding to the physical surface;
receiving an image from a source other than the sensor;
dividing the image into pieces; and
displaying, within the virtual surface, placement indicators each denoting a location on the physical surface to place a physical object corresponding to one of the image pieces.

15. The method of claim 14 further comprising detecting placement of a plurality of the physical objects.

16. The method of claim 15 further comprising:
comparing placement of the plurality of the physical objects to confirm correct placements according to the placement indicators; and
outputting an indication of a physical object having a correct or an incorrect placement upon the placement surface.

17. A computing device comprising:
a sensor configured to detect a physical surface within a line of sight of the sensor;
memory;
a processor coupled to the memory and the sensor, wherein the processor is configured to:
provide a virtual surface corresponding to the physical surface;
receive an image from a source other than the sensor; and
divide the image into pieces; and
display hardware coupled to the processor and memory, wherein the display hardware is configured to display, within the virtual surface, placement indicators each denoting a location on the physical surface to place a physical object corresponding to one of the image pieces.

18. The computing device of claim 17 wherein the processor is further configured to detect placement of a plurality of the physical objects.

19. The computing device of claim 18 wherein the processor is further configured to:
compare placement of the plurality of the physical objects to confirm correct placements according to the placement indicators; and
output an indication of a physical object having a correct or an incorrect placement upon the placement surface.

20. The computing device of claim 17 wherein at least one of the physical objects comprises more than one color.
